(19) United States
(12) Patent Application Publication
(10) Pub. No.: US 2002/0122920 A1
(43) Pub. Date: Sep. 5, 2002

(54) Adhesive recording paper

(75) Inventor: Nozomu Chikami, Shizuoka-ken (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/013,953

(22) Filed: Dec. 13, 2001

(30) Foreign Application Priority Data
Dec. 15, 2000 (JP) 2000-382514

(51) Int. Cl. B32B 3/00

(52) U.S. Cl. 428/195

(57) ABSTRACT

Disclosed is adhesive recording paper having an image-forming layer on one surface of a substrate, and having an adhesive layer and a stripping sheet in that order on the other surface thereof, wherein the ratio, N^{max}/N^{min}, of the maximum stripping force (N^{max}) to the minimum stripping force (N^{min}) needed for separating the stripping sheet from the adhesive layer at a service temperature is at most 3.5, preferably at most 2.0.

### BACKGROUND OF THE INVENTION

1. Field of the Invention

The present invention relates to adhesive recording paper which is favorably used in image-printing systems that are for outputting images formed by computers, images read by scanners, and images taken by digital cameras and the like to give full-color image prints, and which can be adhered to objects.

2. Description of the Related Art

Adhesive recording paper is used as a recording medium in image-printing systems that are for imagewise recording and for outputting image data from computers, scanners, digital cameras etc. The adhesive recording paper having such image data printed thereon is used as seals and the like and can be adhered to various objects. Thus, adhesive recording paper is widely used and has many applications.

Examples of known methods for recording (printing) multi-color images on such adhesive recording paper include (1) a direct thermal recording system of directly forming thereon colors of yellow (Y), magenta (M) and cyan (C) by applying thereto thermal energy from a heating unit such as thermal head; (2) a sublimation conveyance recording system of subliming and transferring dyes onto the image-forming layer of the paper by applying thermal energy to the dyes; (3) an ink thermal conveyance system of melting and transferring ink onto the paper to form images thereon by applying thermal energy to the ink; and in addition (4) an ink-jet recording system, an electrophotographic system, etc. In the method (1), for example, the thermal image-forming layer of adhesive recording paper is directly heated, for example, with a thermal head to thereby form colors of yellow (Y), magenta (M) and cyan (C) to be a multi-color image thereon.

In either of the methods recording (printing) a multi-color image on the recording paper, different colors are generally formed one after another to give the desired multi-color (full-color) image, as in the direct thermal recording system or the sublimation conveyance recording system. In the process, however, if the colors formed are mispositioned, the resulting image will be formed such that two or three color layers are mispositioned and it will be impossible to obtain the desired tone. This significantly decreases the commercial value of the image prints. In particular, even when recording paper is processed under ordinary service conditions, for example, at a temperature falling between 5° C. and 35° C., the recording paper is often affected by the service temperature thereby causing the problem of image mispositioning thereon.

With the recent tendency in the art toward high-quality images, the resolution of printers is increasing, and the market now requires high-quality image prints free of problems of image mispositioning and in which the colors to form images are accurately recorded at their predetermined position. In that situation, it is a matter of great importance to develop adhesive recording paper capable of forming thereon sharp-toned, good multi-color images with no problem of image mispositioning.

Those learned in the art have heretofore improved and modified printers for recording (printing) images on adhesive recording paper, with the intention of accurately recording all imaging colors in the intended position, but no one has succeeded in completely avoiding the problem of image mispositioning. One reason is no one had identified the factors related to the adhesive recording paper itself that might control or prevent the image mispositioning in adhesive recording paper.

As mentioned hereinabove, when adhesive recording paper having an adhesive layer on one of its surfaces is processed to form thereon a multi-color image even under ordinary service conditions of, for example, a temperature falling between 5° C. and 35° C., it is difficult to accurately record all the imaging colors in their predetermined position on the recording paper and to stably form the desired, sharp-toned multi-color image on the paper without the problem of image mispositioning which reduces the quality of the image formed.

### SUMMARY OF THE INVENTION

The present invention seeks to solve the prior-art problems noted above, and to attain the object mentioned below.

Specifically, the object of the invention is to provide adhesive recording paper which is used in a recording process of a direct thermal recording system, a sublimation conveyance recording system or the like for forming colors of yellow (Y), magenta (M) and cyan (C) in order thereon, and which is, when used for recording (printing) multi-color images (letters) thereon, free from the trouble of color mispositioning which results in poor imaging. This adhesive recording paper is therefore capable of stably reproducing thereon reliable, multi-color images of good quality which are vivid and shape-toned and which are not mispositioned.

Having considered that the reason for image mispositioning on adhesive recording paper in the prior-art techniques is poor paper conveyance in the conveyance system in printers, we, the present inventors have studied this problem, and have found the following:

First, adhesive recording paper is so structured such that it has an adhesive layer on one surface and has, on the other surface, an image-forming layer on which images are recorded. When the recording paper is curved in the paper conveyance system in a printer, it will shift slightly or its position in the printer will change a little, depending on the strength (repulsive force) of the curved adhesive layer thereof. Owing to this phenomenon, the distance to which the recording paper actually travels in the printer will vary slightly, though it is transferred all the time at a constant rate therein.

Specifically, physical properties including the strength of the adhesive layer are easily affected by ambient temperatures, etc., and it is believed that, when the adhesive layer whose physical properties have changed passes through the curved portion inside a printer, then the curvature difference, the conveyance resistance and the conveyance distance of the recording paper are mildly affected by the temperature difference. As the result, this may cause image mispositioning on the recording paper.

Secondly, the stripping force refers to the force applied in order to separate the stripping sheet (or the substrate with an image-formed layer thereon) from the adhesive layer. The stripping force can be controlled by suitably selecting and controlling the components and the thickness of the stripping layer to be formed on the stripping face of the stripping sheet. However, the stripping force can not be determined only by the stripping layer, but is generally affected by physical properties including the flexural rigidity of the adhesive layer, the substrate having an image-formed layer thereon and the stripping sheet itself. Accordingly, when an images is recorded on an adhesive recording paper which is comprised of the adhesive layer and the image forming layer whose physical properties are easily affected by service conditions such as temperature and humidity, in order to prevent the image from being mispositioned, it is important that physical properties of the recording material are not affected by temperature changes within the suggested service temperature range.

Having considered the matters noted above, we, the present inventors have found that the properties of the adhesive layer of adhesive recording paper which may cause poor conveyance of the paper in the conveyance system in a printer are correlated with the stripping force needed for separating the stripping sheet from the adhesive layer of the image-recorded adhesive paper. This discovery has led us to achieve the above-mentioned object of the invention. The specific means for achieving the object is described below.

The invention provides adhesive recording paper having an image-forming layer on one surface of a substrate, and having an adhesive layer and a stripping sheet in that order on the other surface thereof, wherein the ratio, N^{max}/N^{min}, of the maximum stripping force (N^{max}) to the minimum stripping force (N^{min}) needed for separating the stripping sheet from the adhesive layer at the service temperature is at most 3.5.

Preferably, the service temperature is a recommended service temperature falling between 5 and 35° C.

One embodiment of the invention is the adhesive recording paper for which the ratio, N^{max}/N^{min}, is at most 2.0.

Another embodiment of the invention is the adhesive recording paper, for which the ratio, N⁵/N²³, of the stripping force (N⁵) at a service temperature of 5° C. to the stripping force (N²³) at a service temperature of 23° C. falls between 0.7 and 1.3.

Still another embodiment of the invention is the adhesive recording paper, for which the ratio, N³⁵/N²³, of the stripping force (N³⁵) at a service temperature of 35° C. to the stripping force (N²³) at a service temperature of 23° C. falls between 0.7 and 2.0.

Still another embodiment of the invention is the adhesive recording paper wherein the image-forming layer is a thermal recording layer for use in a thermal recording process in which image formation is carried out on the thermal recording layer by heat being applied thereto, and the thermal recording layer contains colloidal silica. One preferred embodiment of the thermal recording process for image formation in the image-forming layer of the adhesive recording paper of the type is a direct thermal recording process in which the image-forming layer is directly exposed to heat for image formation.

Still another embodiment of the invention is the adhesive recording paper in which the image-forming layer is a thermal recording layer for use in a thermal recording process in which image formation is carried out on said thermal recording layer by heat being applied thereto, and the thermal recording layer is coated with a protective layer that contains colloidal silica.

### BRIEF DESCRIPTION OF THE DRAWING

FIG. 1 is a schematic cross-sectional view showing one example of the layer constitution of the adhesive recording paper of the invention. In FIG. 1, 1 indicates an image-forming layer, 2 indicates a substrate, 3 indicates an adhesive layer, and 4 indicates a stripping sheet.

### DETAILED DESCRIPTION OF THE INVENTION

In the adhesive recording paper of the invention, the adhesive layer to be provided on the surface of the substrate (support) is so controlled that the ratio, N^{max}/N^{min} at a service temperature, of the maximum stripping force (N^{max}) to the minimum stripping force (N^{min}) needed for separating the stripping sheet from the adhesive layer at a service temperature is at most 3.5. The adhesive recording paper of the invention is described in detail hereinafter.

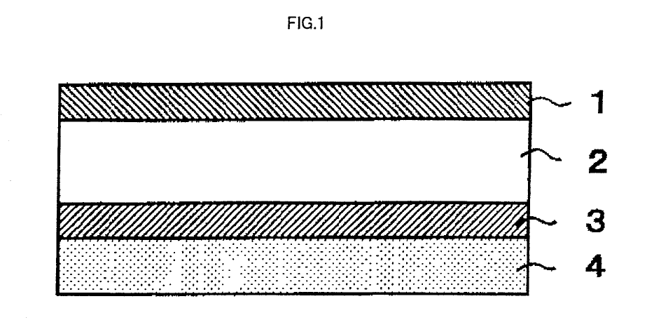

The adhesive recording paper of the invention has an image-forming layer on one surface of a substrate, and has an adhesive layer and a stripping sheet in that order on the other surface thereof. Preferably, the image-forming layer is coated with a protective layer. Optionally, the adhesive recording paper may have any other layers such as a transmittance control layer (see FIG. 1). Also preferably, the image-forming layer is a thermal recording layer that receives heat to form colors therein, and the adhesive recording paper of this embodiment having such a thermal recording layer is suitable for a thermal recording system in which the layer is exposed imagewise to heat to form images therein. FIG. 1 is a schematic cross-sectional view showing one example of the layer constitution of the adhesive recording paper of the invention.

Adhesive Layer:

The adhesive layer contains at least an adhesive, and it enables the paper with an image formed thereon to adhere to objects. Therefore, for ensuring good paper conveyance in printers, the adhesive layer is coated with a stripping sheet which is described hereinunder.

For function, the adhesive layer has the necessary adhesiveness that enables the paper to adhere to objects. However, depending on its ability to resist bending (repulsive force), the adhesive layer may cause poor paper conveyance in printers. Therefore, in the invention, the adhesive layer is specifically controlled in the manner mentioned below.

Specifically, the adhesive layer is so controlled that the ratio, N^{max}/N^{min}, of the maximum stripping force (N^{max}) to the minimum stripping force (N^{min}) needed for separating the stripping sheet from the adhesive layer at a service temperature is at most 3.5. Preferably, the service temperature falls between 5 and 35° C. (recommended service temperature).

If the ratio N^{max}/N^{min} is larger than 3.5, the stripping force needed for separating the two is too high, or that is, the repulsive force of the adhesive layer, when curved, is too high; and if so, the recording paper often shifts at the curved portion in the paper conveyance unit in printers. As a result, when a multi-color image is formed on the recording paper by forming colors in order, the colors formed will be mispositioned and the resulting image will be formed such that two or three color layers will be mispositioned and it will be impossible to obtain the desired tone. As a result, good multi-color images could not be formed on the paper, and the commercial value of the image prints is extremely low.

More preferably, the ratio N^{max}/N^{min} is at most 2.0, in order to more effectively avoid the poor paper conveyance in printers and to more stably form good and sharp multi-color images on the paper.

Naturally, it is desirable that the ratio N^{max}/N^{min} is 1 and the properties of the adhesive layer do not change under any service condition. However, the stripping force to separate the stripping sheet from the adhesive layer is easily affected by service conditions, and in particular, is affected to a great extent by ambient temperatures. This means that the physical properties including the adhesive force and the rigidity of the adhesive layer of the adhesive recording paper are affected by ambient temperatures and other conditions. It is believed that, when the adhesive recording paper in which the physical properties of the adhesive layer have changed passes through the curved portion inside a printer, then the curvature difference, the conveyance resistance and the conveyance distance of the recording paper are mildly affected by the service temperature at which the paper is processed. This may cause image mispositioning on the recording paper.

Accordingly, in order to prevent mispositioning of the image-recorded (printed) on the recording paper, it is important that the paper not significantly affected by ambient temperature changes within the recommended service temperature range (for example, from 5 to 35° C). To that effect, therefore, the image quality degradation to be caused by poor paper conveyance in printers can be prevented if the properties of the adhesive layer of the recording paper are so controlled that they do not exceed a predetermined range even though the ambient temperature of the paper has changed.

As mentioned hereinabove, the stripping force to separate the stripping sheet from the adhesive layer is readily affected by the service conditions under which the adhesive recording paper is processed, and is particularly affected by the ambient temperature of the paper. Therefore, it is desirable that the stripping force is so controlled as to satisfy the requirements mentioned below, with respect to the ambient temperature at which the paper is processed (for recording images thereon).

Specifically, it is desirable that, in a low temperature range, the ratio, N⁵/N²³, of the stripping force (N⁵) at a service temperature of 5° C. to the stripping force (N²³) at a service temperature of 23° C. (room temperature) falls between 0.7 and 1.3, more preferably between 0.8 and 1.2. In a high temperature range, it is desirable that the ratio, N³⁵/N²³, of the stripping force (N³⁵) at a service temperature of 35° C. to the stripping force (N²³) at a service temperature of 23° C. (room temperature) falls between 0.7 and 2.0, more preferably between 0.7 and 1.5.

If the stripping force does not fall within the range defined above in the ambient temperature range in which the recording paper is processed (for recording images thereon), the recording paper will shift in the curved portion inside a printer, or the distance by which the paper has actually been conveyed will vary slightly, and, as a result, the colors formed one after another to give a multi-color image on the recording paper will be mispositioned. If the image is mispositioned, it becomes impossible to reproduce a multi-color image having the desired color tone without the problem of image mispositioning.

The stripping force referred to herein indicates the force necessary for separating the stripping sheet that will be described hereinunder (or the substrate with an image-recorded layer thereon) from the adhesive layer, and it may be measured by a 180°-peeling method in which the stripping sheet or the substrate is peeled at a peeling rate of 300 mm/min.

In the invention, a preferred method for controlling the stripping force for separating the stripping sheet from the adhesive layer to fall within the defined range as above, is controlling the formulation of the adhesive component which constitutes the adhesive layer. Specifically, any of the adhesives mentioned below may be preferably used for the adhesive layer.

The adhesives include, for example, rubber adhesives such as those of synthetic or natural rubber combined with a tackifying resin and a softener; acrylic adhesives such as copolymers obtained through emulsion polymerization or solution polymerization of acrylates and other functional acrylic compounds; and silicone adhesives such as those of silicone rubber combined with silicone resin. Above all, preferred are acrylic adhesives, as they are inexpensive and resistant to weathering. In view of their adhesive properties, also preferred are crosslinkable adhesives having high cohesive power, such as two-component, crosslinkable acrylic adhesives that contain a crosslinking agent.

The adhesive layer may be formed by applying an adhesive-containing coating liquid (adhesive layer-forming coating liquid) onto a substrate, for example, according to known coating methods. The known coating methods employable herein include, for example, a comma coating method, a gravure coating method, a kiss coating method and a reverse coating. The invention is, however, not limited to these methods. Of these methods, especially preferred is a comma coating method as it ensures uniform coating and gives a layer having a smooth surface.

The thickness of the adhesive layer is not specifically defined, and may be suitably determined depending on the object of the invention. For better adhesiveness of the layer to objects, however, the thickness of the adhesive layer preferably falls between 5 and 30 μm, more preferably between 10 and 20 μm.

Stripping Sheet:

The adhesive recording paper of the invention has a stripping sheet to cover the adhesive layer formed on the substrate. The sheet is so disposed on the adhesive layer that it can be separated from the adhesive layer at the interface between the two. The stripping sheet may be disposed on the adhesive layer in any desired manner providing it does not interfere with its ability to be stripped.

Concrete examples of the material for the stripping sheet are polyethylene terephthalate film and its foamed film, polyamide film, polyaramide film, polycarbonate film, polysulfone film, cellophane, polypropylene film, synthetic paper, coated paper, woodfree paper, kraft paper, glassine paper, etc. If desired, the stripping sheet of paper material is preferably coated with a sealant.

Of the above, preferred are foamed polyethylene terephthalate film and synthetic paper, as they are cushiony and their surface is smooth.

Optionally, the face of the stripping sheet which is in direct contact with the adhesive layer (this face will be hereinafter referred to as “stripping face”) may be coated in advance with a stripping agent that facilitates the separation of the stripping film from the adhesive layer. The stripping agent is not specifically defined, and may be selected from silicone materials and non-silicone materials depending on the object and the use of the recording paper. The stripping agent may be applied to the stripping sheet by any known coating method. The methods of forming the adhesive layer mentioned hereinabove may be used as a reference.

For the same reason as above, the surface of the image-forming layer and/or the substrate may be half-cut in advance.

Optionally, an ink-receiving layer may be provided on the face opposite to the stripping face of the stripping sheet; or a mark for inspection in printers may be printed in advance or put thereon through perforation or the like; or a brand, directions and the like may be printed thereon.

Image-Forming Layer:

The image-forming layer is for recording (printing) images (letters) on the adhesive recording paper. The recording mode is not specifically defined, but for example, the layer may be (1) a thermal recording layer on which images are formed by a thermal recording method of directly heating the layer with a heating unit such as thermal head; or (2) a thermal sublimation conveyance layer on which images are formed by a thermal sublimation conveyance method of heating dyes with a heating unit such as thermal head and transferring them onto the layer; or (3) a thermal ink conveyance layer on which images are formed by a thermal ink conveyance method of melting ink with a heating unit such as thermal head and transferring it onto the layer. In any of these recording modes, images of high resolution and high gradation can be formed on the image-forming layer.

In the adhesive recording paper of the invention, it is desirable that colloidal silica is included in the image-forming layer or in a protective layer optionally formed on the image-forming layer, for further improving the suitability of the layer for use with heating units such as thermal heads (specifically, for preventing heads from being worn or soiled).

For the thermal recording layer (1) to be processed according to a thermal recording method, for example, mentioned are multi-color thermal recording media described in JP-A Nos. 48-86543 and 51-146239. As described therein, two thermal color-forming layers that form different colors are provided in one recording medium, in which each thermal color-forming layer contains a dye to give a specific color and a developer. With these, the recording medium is heated in such a controlled manner that the two thermal color-forming layers receive a different quantity of heat, and, after being thus heated, two-color images that can be differentiated from each other are formed in the recording medium.

Also given as examples are thermal recording media described in JP-A Nos. 55-81193 and 2-80287. As described therein, the recording medium contains a color eraser that acts on the color-forming mechanism of the low-temperature color-forming layer to erase the color therein when heated at a high temperature, and only the high-temperature color-forming layer in this forms a color when heated at a high temperature to thereby form an image on the medium.

Also mentioned are thermal recording media described in JP-A Nos. 60-242093 and 61-40192, which contain a photo-degradable diazo compound and a coupler and in which the diazo compound is coupled with the coupler to form a color. The action of heat and the action of light are combined to form not only monochromatic images through individual coloration of each color-forming layer therein but also mixed-color images through composite coloration of plural color-forming layers therein. The recording media of this type can form different multi-color images, depending on their object.

An example of thermal sublimation conveyance layer (2) to be processed according to a thermal sublimation conveyance method is a thermal sublimation conveyance image-receiving layer that contains a thermoplastic resin having an affinity to dye and capable of fixing dye, or its crosslinked product. In general, the thermoplastic resin is preferably a polyester resin, but may also be any of epoxy resins, vinyl chloride copolymers and polycarbonates. If desired, a crosslinking agent may be included. The crosslinking agent is reactive with the functional groups in the resin, including, for example, polyfunctional isocyanates.

An example of a thermal ink conveyance layer (3) to be processed according to a thermal ink conveyance method is a layer that contains an oil-absorbing dye and a binder. For the oil-absorbing dye, usable are various fillers that include, for example, hexagonal pillar-shaped or conical, precipitated calcium carbonate of all types, heavy calcium carbonate, clay of all types, calcined clay, titanium dioxide, aluminium hydroxide, talc, calcium silicate, calcium sulfate, magnesium silicate, and synthetic amorphous silica. Other examples include a thermal ink conveyance layer that contains resin such as polyester resin optionally along with pigment.

One preferred embodiment of the image-forming layer in the invention is like the above-mentioned thermal recording layer (1). The thermal recording material that comprises such a thermal recording layer is described in detail hereinunder.

Thermal Recording Layer:

The thermal recording layer contains at least a diazonium salt compound and a coupler capable of coupling with the diazonium salt compound to form a color; or at least an electron-donating dye precursor and an electron-receiving compound capable of reacting with the electron-donating dye precursor to form a color. Preferably, it further contains colloidal silica, when not coated with a protective layer that will be mentioned hereinafter. Optionally, it may contain any other components, such as an organic base, a sensitizer, a binder, an antioxidant, etc.

Diazonium Salt Compound:

The diazonium salt compound includes, for example, those of the following formula (1):

Ar—N₂⁺X⁻ (1)

wherein Ar represents an aromatic moiety, and X⁻ represents an acid anion.

When heated, the diazonium salt compound is coupled with a coupler that will be mentioned hereinunder, to thereby form a color, and is degraded when exposed to light. Depending on the site and the type of the substituent in the moiety Ar therein, the maximum absorption wavelength for the compound can be controlled.

Examples of the diazonium moiety to form the salt are 4-(p-tolylthio)-2,5-dibutoxybenzenediazonium, 4-(4-chlorophenylthio)-2,5-dibutoxybenzenediazonium, 4-(N,N-dimethylamino)benzenediazonium, 4-(N,N-diethylamino)benzenediazonium, 4-(N,N-dipropylamino)benzenediazonium, 4-(N-methyl-N-benzylamino)benzenediazonium, 4-(N,N-dibenzylamino)benzenediazonium, 4-(N-ethyl-N-hydroxyethylamino)benzenediazonium, 4-(N,N-diethylamino)-3-methoxybenzenediazonium, 4-(N,N-dimethylamino)-2-methoxybenzenediazonium, 4-(N-benzoylamino)-2,5-diethoxybenzenediazonium, 4-morpholino-2,5-dibutoxybenzenediazonium, 4-anilinobenzenediazonium, 4-[N-(4-methoxybenzoyl)amino]-2,5-diethoxybenzenediazonium, 4-pyrrolidino-3-ethylbenzenediazonium, 4-[N-(l-methyl-2-(4-methoxyphenoxy)ethyl)-N-hexylamino]-2-hexyloxybenzenediazonium, 4-[N-(2-(4-methoxyphenoxy)ethyl)-N-hexylamino]-2-hexyloxybenzenediazonium, 2-(1-ethylpropyloxy)-4-[di-(di-n-butylaminocarbonylmethyl)amino]benzenediazonium, and 2-benzylsulfonyl-4-[N-methyl-N-(2-octanoyloxyethyl)]aminobenzenediazonium.

The maximum absorption wavelength λmax for the diazonium salt compound is preferably at most 450 nm, more preferably falling between 290 and 440 nm. If λmax is in a wavelength range longer than 450 nm, the storability of the raw material will be poor. If, on the other hand, λmax is in a wavelength range shorter than the range defined as above, the image fixation and the image storability will be poor, depending on the combination of the compound and the coupler that will be described hereinafter, and the quality of cyan color will be poor.

Preferably, the diazonium salt compound has at least 12 carbon atoms, and its solubility in water is at most 1% but is at least 5% in ethyl acetate.

One diazonium salt compound maybe included in the thermal recording layer, but two or more different types of diazonium salts may be included therein for controlling the color to be formed in the layer.

Preferably, the amount of the diazonium salt compound included in the thermal recording layer falls between 0.05 and 2 g/m², and more preferably between 0.1 and 1 g/m². If its content is less than 0.05 g/m², the color density of the layer will be often unsatisfactory; but if greater than 2 g/m², the coatability of the coating liquid to form the layer will be often poor.

Coupler:

The coupler that couples with the above-mentioned diazonium salt compound to form a coloring dye may be any one capable of coupling with the diazonium salt compound in a basic atmosphere and/or a neutral atmosphere to form the desired dye.

Four-equivalent couplers generally used in silver halide photographic materials are all usable herein, and any one of them may be suitably selected in accordance with the color which the layer is desired to have.

Examples of the coupler include active methylene compounds having a methylene group adjacent to the carbonyl group therein, phenol derivatives, and naphthol derivatives.

Examples of the coupler are resorcine, phloroglucine, 2,3-dihydroxynaphthalene, 2,3-dihydroxynaphthalene-6-sodium sulfonate, 1-hydroxy-2-naphthoic acid morpholinopropylamide, 2-hydroxy-3-sodium naphthalenesulfonate, 2-hydroxy-3-naphthalenesulfonic acid anilide, 2-hydroxy-3-naphthalenesulfonic acid morpholinopropylamide, 2-hydroxy-3-naphthalenesulfonic acid 2-ethylhexyloxypropylamide, 2-hydroxy-3-naphthalenesulfonic acid 2-ethylhexylamide, 5-acetamido-1-naphthol, 1-hydroxy-8-acetamidonaphthalene-3,6-disodium sulfonate, 1-hydroxy-8-acetamidonaphthalene-3,6-disulfonic acid dianilide, 1,5-dihydroxynaphthalene, 2-hydroxy-3-naphthoic acid morpholinopropylamide, 2-hydroxy-3-naphthoic acid octylamide, 2-hydroxy-3-naphthoic acid anilide, 5,5-dimethyl-1,3-cyclohexanedione, 1,3-cyclopentanedione, 5-(2-n-tetradecyloxyphenyl)-1,3-cyclohexanedione, 5-phenyl-4-methoxycarbonyl-1,3-cyclohexanedione, 5-(2,5-di-n-octyloxyphenyl)-1,3-cyclohexanedione, N,N′-dicyclohexylbarbituric acid, N,N′-di-n-dodecylbarbituric acid, N-n-octyl-N′-n-octadecylbarbituric acid, N-phenyl-N′-(2,5-di-n-octyloxyphenyl) barbituric acid, N,N′-bis(octadecyloxycarbonylmethyl) barbituric acid, 1-phenyl-3-methyl-5-pyrazolone, 1-(2,4,6-trichlorophenyl)-3-anilino-5-pyrazolone, 1-(2,4,6-trichlorophenyl)-3-benzamido-5-pyrazolone, 6-hydroxy-4-methyl-3-cyano-1-(2-ethylhexyl)-2-pyridone, 2,4-bis(benzoylacetamido)toluene, 1,3-bis(pivaloylacetamidomethyl)benzene, benzoylacetonitrile, thenoylacetonitrile, acetoacetanilide, benzoylacetanilide, pivaloylacetanilide, 2-chloro-5-(N-n-butylsulfamoyl)-1-pivaloylacetamidobenzene, 1-(2-ethylhexyloxypropyl)-3-cyano-4-methyl-6-hydroxy-1,2-dihydropyridin-2-one, 1-(dodecyloxypropyl)-3-acetyl-4-methyl-6-hydroxy-6-hydroxy-1,2-dihydropyridin-2-one, and 1-(4-n-octyloxyphenyl)-3-tert-butyl-5-aminopyrazole.

The details of the above-mentioned couplers are described, for example, in JP-A Nos. 4-201483, 7-223367, 7-223368, 7-323660, and Japanese Patent Application Nos. 5-278608, 5-297024, 6-18669, 6-18670, 7-316280, 8-027095, 8-027096, 8-030799, 8-12610, 8-132394, 8-358755, 8-358756, 9-069990.

The coupler content of the thermal recording layer preferably falls between 0.1 and 30 parts by weight, relative to one part by weight of the diazonium salt compound in the layer.

The color-forming components of the thermal recording material of the invention may be a combination of an electron-donating dye precursor and an electron-receiving compound (leuco-based colorant), in addition to the above-mentioned combination of a diazonium salt compound and a coupler (diazo-based colorant) . For example, in the thermal recording material having plural thermal recording layers on its support, at least one of the thermal recording layers may be a layer containing a leuco-based colorant.

Examples of the electron-donating dye precursor include, for example, triarylmethane compounds, diphenylmethane compounds thiazine compounds, xanthene compounds, and spiropyran compounds. Of those, preferred are triarylmethane compounds and xanthene compounds since they give high-density colors.

Specific examples of the compounds include the following compounds: 3,3-bis(p-dimethylaminophenyl)-6-dimethylaminophthalide (that is, crystal violet lactone), 3,3-bis(p-dimethylamino)phthalide, 3-(p-dimethylaminophenyl)-3-(1,3-dimethylindol-3-yl)phthalide, 3-(p-dimethylaminophenyl)-3-(2-methylindol-3-yl)phthalide, 3-(o-methyl-p-diethylaminophenyl)-3-(2-methylindol-3-yl)phthalide, 4,4′-bis (dimethylamino)benzhydryl benzyl ether, N-halophenyl-leucoauramines, N-2,4,5-trichlolrophenyl-leucoauramine, rhodamine-B-anilinolactam, rhodamine(p-nitroanilino)lactam, rhodamine-B-(p-chloroanilino)lactam, 2-benzylamino-6-diethylaminofluoran, 2-anilino-6-diethylaminofluoran, 2-anilino-3-methyl-6-diethylaminofluoran, 2-anilino-3-methyl-6-cyclohexylmethylaminofluoran, 2-anilino-3-methyl-6-isoamylethylaminofluoran, 2-(o-chloroanilino)-6-diethylaminofluoran, 2-octylamino-6-diethylaminofluoran, 2-ethoxyethylamino-3-chloro-2-diethylaminofluoran, 2-anilino-3-chloro-6-diethylaminofluoran, benzoyl-leucomethylene blue, p-nitrobenzyl-leucomethylene blue, 3-methyl-spiro-dinaphthopyran, 3-ethyl-spiro-dinaphthopyran, 3,3′-dichloro-spiro-dinaphthopyran, 3-benzylspirodinaphthopyran, and 3-propyl-spiro-dibenzopyran.

The amount of the electron-donating dye precursor to be included in the thermal recording layer preferably falls between 0.1 and 1 g/m² for the same reason as that for the diazonium salt compound mentioned above.

Examples of the electron-receiving compound include phenol derivatives, salicylic acid derivatives, and hydroxybenzoates. Of those, especially preferred are bisphenols and hydroxybenzoates. Specifically, they include the following compounds:

2,2-Bis (p-hydroxyphenyl)propane (that is, bisphenol A), 4,4′-(p-phenylenediisopropylidene)diphenol (that is, bisphenol P), 2,2-bis(p-hydroxyphenyl)pentane, 2,2-bis(p-hydroxyphenyl)ethane, 2,2-bis(p-hydroxyphenyl)butane, 2,2-bis (4′-hydroxy-3′,5′-dichlorophenyl)propane, 1, 1-(p-hydroxyphenyl)cyclohexane, 1,1-(p-hydroxyphenyl)propane, 1,1-(p-hydroxyphenyl)pentane, 1,1-(p-hydroxyphenyl)-2-ethylhexane, 3,5-di(α-methylbenzyl)salicylic acid and its polyvalent metal salts, 3,5-di(tert-butyl)salicylic acid and its polyvalent metal salts, 3-α, α-dimethylbenzylsalicylic acid and its polyvalent metal salts, butyl p-hydroxybenzoate, benzyl p-hydroxybenzoate, 2-ethylhexyl p-hydroxybenzoate, p-phenylphenol, and p-cumylphenol.

The amount of the electron-accepting compound to be used in the thermal recording layer preferably falls between 0.1 and 30 parts by weight relative to 1 part by weight of the electron-donating dye precursor therein.

Colloidal Silica:

In the adhesive recording paper of the invention, colloidal silica may be included in the layer (e.g., image-forming layer, protective layer) that is to be in contact with a heating unit such as thermal head, to thereby improve the suitability of the layer for use with thermal heads (specifically, thermal heads to be brought into contact with the layer are prevented from being worn or soiled).

The colloidal silica may be anionic colloidal silica or the like. The anionic colloidal silica may be prepared, for example, by dispersing ultra-fine particles of silicic anhydride in water. The commercial product is available, and, for example, Nissan Chemical's Snowtex O is preferred.

Preferably, the particle size of the colloidal silica for use herein falls between 5 and 60 nm, more preferably between 10 and 25 nm. If it is too fine, that is a particle size of smaller than 5 nm, its bonding force will increase too much; but if too large, that is a particle size of larger than 60 nm, its frictional force will increase.

The colloidal silica content of the thermal recording layer preferably falls between 1.0 and 20% by weight, more preferably between 1.5 and 12% by weight of the total solid content (by weight) of the layer.

Next described are the other components that may be included in the thermal recording layer.

Organic Base:

It is desirable that the layer contains an organic base that promotes the coupling reaction of the diazonium salt and the coupler therein.

Preferably, the organic base is in the photosensitive thermal recording layer along with a diazonium salt and a coupler, and one or more different types of it maybe used therein either singly or combined.

Examples of the organic base include nitrogen-containing compounds such as tertiary amines, piperidines, piperazines, amidines, formamidines, pyridines, guanidines and morpholines. In addition, also usable herein are the compounds described in JP-B 52-46806; JP-A 62-70082, 57-169745, 60-94381, 57-123086, 60-49991; JP-B Nos. 2-24916, 2-28479; and JP-A Nos. 60-165288, and 57-185430.

When used, the amount of the organic base included in the thermal recording layer preferably falls between 0.1 and 30 parts by weight relative to 1 part by weight of the diazonium salt compound therein.

Sensitizer:

In addition to the organic base mentioned above, the thermal recording layer may also contain a sensitizer for promoting the color-forming reaction therein. The sensitizer is a substance that acts to increase the color density achieved or to lower the lowermost color-forming reaction temperature needed in the process of thermal recording. Specifically, it lowers the melting point of the coupler, the organic base or the diazonium salt in the layer or lowers the softening point of the capsule wall that envelops the components therein, thereby enhancing the reactivity of the diazonium salt, the organic base and the coupler.

Specifically, low-melting-point organic compounds having suitable amount of aromatic groups and polar groups in the molecule are preferred for the sensitizer. Examples include benzyl p-benzyloxybenzoate, α-naphthyl benzyl ether, β-naphthyl benzyl ether, phenyl β-naphthoate, phenyl α-hydroxy-β-naphthoate, β-naphthol (p-chlorobenzyl) ether, 1,4-butanediol phenyl ether, 1,4-butanediol p-methylphenyl ether, 1,4-butanediol p-ethylphenyl ether, 1,4-butanediol m-methylphenyl ether, 1-phenoxy-2-(p-tolyloxy)ethane, 1-phenoxy-2-(p-ethylphenoxy)ethane, 1-phenoxy-2-(p-chlorophenoxy)ethane, and p-benzylbiphenyl.

Binder:

The binder that may be included in the thermal recording layer, may be any known water-soluble polymer compound and latexes.

Examples of the water-soluble polymer compounds include methyl cellulose, carboxymethyl cellulose, hydroxyethyl cellulose, hydroxypropyl cellulose, starch derivatives, casein, arabic gum, gelatin, ethylene-maleic anhydride copolymer, styrene-maleic anhydride copolymer, polyvinyl alcohol, epichlorohydrin-modified polyamide, isobutylene-maleinsalicylic anhydride copolymer, polyacrylic acid, polyacrylic acid amide, and their modified derivatives; and the latexes include, for example, styrene-butadiene rubber latex, methyl acrylate-butadiene rubber latex, and polyvinyl acetate emulsion.

Antioxidant:

For improving the fastness to light and heat of color images formed, and for preventing the non-printed part (non-image part) of prints from yellowing in light after image fixation, it is also desirable to use herein some known antioxidant mentioned below.

The antioxidant includes, for example, those described in EP-A 223739, 309401, 309402, 310551, 310552, 459416; German Patent(A) 3435443; JP-A Nos. 54-48535, 62-262047, 63-113536, 63-163351, 2-262654, 2-71262, 3-121449, 5-61166, 5-119449; and U.S. Pat. Nos. 4814262, 4980275.

In the invention, the mode of using the components of coupler, colloidal silica, organic base, sensitizer and others is not specifically defined, and, for example, employable are (1) a method of dispersion them in solid, (2) a method of dispersing them through emulsification, (3) a method of dispersing them with polymer, (4) a method of dispersing them with latex, and (5) a method of encapsulating them into microcapsules.

Microcapsules and their Production:

In the invention, it is desirable to encapsulate the diazonium salt (as well as the electron-donating dye precursor) into microcapsules for further improving the storage stability of the thermal recording material, especially the storability with respect to the whiteness of the background area of the material.

For encapsulating the color-forming components into microcapsules, herein employable is any known method. A preferred example is an interfacial polymerization method, which comprises dissolving or dispersing one color-forming component, the diazonium salt compound (or the electron-donating dye precursor) in an organic solvent that is hardly soluble or insoluble in water; mixing the resulting oily phase with an aqueous phase that contains a water-soluble polymer dissolved therein; emulsifying and dispersing it by the use of a homogenizer or the like; and heating it to induce polymer-forming reaction in the interface that surrounds the oil drops therein to thereby form microcapsule walls of the polymer substance. In the interfacial polymerization method, microcapsules all of the same size can be formed within a short period of time; and using them, recording materials of good storability can be obtained.

The organic solvent may be low-boiling-point auxiliary solvents such as acetates, methylene chloride and cyclohexanone, and/or others of phosphates, phthalates, acrylates, methacrylates, other carboxylates, fatty acid amides, alkylated biphenyls, alkylated terphenyls, alkylated naphthalenes, diarylethanes, chloroparaffins, alcohol solvents, phenol solvents, ether solvents, mono-olefin solvents, epoxy solvents, etc.

For the water-soluble polymer, usable are polyvinyl alcohol and the like. Examples include polyvinyl alcohol, silanol-modified polyvinyl alcohols, carboxyl-modified polyvinyl alcohol, amino-modified polyvinyl alcohol, itaconic acid-modified polyvinyl alcohol, styrene-maleic anhydride copolymer, butadiene-maleic anhydride copolymer, ethylene-maleic anhydride copolymer, isobutylene-maleic anhydride copolymer, polyacrylamide, polystyrenesulfonic acid, polyvinylpyrrolidone, ethylene-acrylic acid copolymer, and gelatin. of those, preferred is carboxyl-modified polyvinyl alcohol.

A hydrophobic polymer emulsion or latex may be used along with the water-soluble polymer. The emulsion or latex may be any of styrene-butadiene copolymer, carboxyl-modified styrene-butadiene copolymer or acrylonitrile-butadiene copolymer. If desired, any known surfactant or the like may be added thereto.

Examples of the polymer substance for forming the microcapsule walls include polyurethane resin, polyurea resin, polyamide resin, polyester resin, polycarbonate resin, aminoaldehyde resin, melamine resin, polystyrene resin, styrene-acrylate copolymer resin, styrene-methacrylate copolymer resin, gelatin, and polyvinyl alcohol. Of those, especially preferred is polyurethane-polyurea resin.

For example, microcapsule walls of polyurethane-polyurea resin that serve as a microcapsule-forming material may be formed as follows: A microcapsule wall precursor such as a polyisocyanate is mixed in an oily medium (oily phase) that is to be encapsulated as a core substance; while, on the other hand, a second substance to react with the microcapsule wall precursor to form microcapsule walls (for example, polyol, polyamine) is mixed in an aqueous solution (aqueous phase) of a water-soluble polymer; and the oily phase is emulsified and dispersed in the aqueous phase, and heated to induce polymer-forming reaction at the interface around the oil drops to thereby form microcapsule walls around them in the resulting dispersion.

Examples of the polyisocyanate compound are mentioned below, which, however, are not limitative: Diisocyanates such as m-phenylene diisocyanate, p-phenylene diisocyanate, 2,6-tolylene 2,4-tolylene diisocyanate, naphthalene-1,4-diisocyanate, diphenylmethane-4,4′-diisocyanate, diisocyanate, 3,3′-diphenylmethane-4,4′-diisocyanate, xylene-1,4-diisocyanate, 4,4′-diphenylpropane diisocyanate, trimethylene diisocyanate, hexamethylene diisocyanate, propylene-1,2-diisocyanate, butylene-1,2-diisocyanate, cyclohexylene-1,2-diisocyanate, cyclohexylene-1,4-diisocyanate; triisocyanates such as 4,4′,4″-triphenylmethane triisocyanate, toluene-2,4,6-triisocyanate; tetraisocyanates such as 4,4′-dimethylphenylmethane-2,2′,5,5′-tetraisocyanate; and isocyanate prepolymers such as hexamethylene diisocyanate/trimethylolpropane adduct, 2,4-tolylene diisocyanate/trimethylolpropane adduct, xylylene diisocyanate/trimethylolpropane adduct, tolylene diisocyanate/hexanetriol adduct.

If desired, two or more different types of such polyisocyanates may be combined and used herein. Particularly preferred are polyisocyanates having at least three isocyanate groups in the molecule.

In the method of forming the microcapsules, the organic solvent to be used for dissolving or dispersing the other components, coupler (or electron-receiving compound), colloidal silica, organic base, sensitizer, and also the microcapsule wall precursor and the second substance that reacts with the precursor may be the same as those mentioned hereinabove.

The particle size of the microcapsules preferably falls between 0.1 and 2.0 μm, more preferably between 0.2 and 1.5 μm.

Next described are specific embodiments with respect to the constitution of the multi-color recording material of the invention.

The thermal recording material of the invention is mainly for multi-color image formation and generally has on a support, a laminate thermal recording layer essentially composed of different monochromatic recording layers. The invention is, however, not limited to this structure and a thermal recording material having a single-layered thermal recording layer may also be used. Preferably, the outermost layer of thermal recording layer of the material is a single-layered or multi-layered protective layer.

In the multi-layered thermal recording material, at least one of the layers which constitute the laminate-structured thermal recording layer is preferably a photo-fixing recording layer that contains a diazonium salt compound and a coupler capable of reacting with the diazonium salt compound to form a color.

Especially in the thermal recording material for formation of full-color images containing cyan, yellow and magenta, it is desirable that all the three color-forming layers on the support respectively comprise diazo-based colorants, or the first thermal recording layer nearest to the support comprises a leuco-based colorant that contains an electron-donating dye precursor and an electron-receiving compound while the second and third thermal recording layers respectively comprise diazo-based colorants.

Protective Layer:

Preferably, the adhesive recording paper of the invention has a single-layered or multi-layered protective layer on the image-forming layer (preferably, on the thermal recording layer). More preferably, the protective layer contains colloidal silica. With the protective layer containing colloidal silica therein, the suitability of the recording paper for use with a heating unit such as thermal head is improved (for example, the thermal head which contacts the recording paper is prevented from being soiled) . In addition, the recording paper is free from the problem of image mispositioning, and the overall quality of the images formed thereon is improved.

The protective layer contains a binder and various components such as colloidal silica, crosslinking agent, pigment, lubricant, surfactant, dispersant, fluorescent brightener, metal soap, hardener, Uv absorbent, etc.

The colloidal silica for use in the thermal recording layer may be any one mentioned hereinabove. The colloidal silica content of the protective layer preferably falls between 1.0 and 20% by weight, and more preferably between 1.5 and 12% by weight of the total solid content (by weight) of the layer.

Providing that the amount is such that the barrier property and the processability of the recording paper is not affected, the binder may be selected, for example, from polyvinyl alcohol, methyl cellulose, carboxymethyl cellulose, hydroxyethyl cellulose, starches, gelatin, arabic gum, casein, styrene-maleic anhydride copolymer hydrolyzates, ethylene maleic anhydride copolymer hydrolyzates, isobutylene-maleic anhydride copolymer hydrolyzates, polyvinyl alcohol, modified polyvinyl alcohol and polyacrylamide.

In addition to the above, also usable for the binder are synthetic rubber latex and synthetic resin emulsion, including, for example, styrene-butadiene rubber latex, acrylonitrile-butadiene rubber latex, methyl acrylate-butadiene rubber latex, and polyvinyl acetate emulsion.

The binder content of the protective layer preferably falls between 10 and 500% by weight, more preferably between 50 and 400% by weight of the pigment content thereof.

For further improving the waterproofness of the protective layer, it is effective to add to the layer a crosslinking agent along with a catalyst that promotes the crosslinking reaction thereof. The crosslinking agent includes, for example, epoxy compounds, blocked isocyanates, vinylsulfone compounds, aldehyde compounds, methylol compounds, boric acids, carboxylic acid anhydrides, silane compounds, chelated compounds and halides, and is preferably one capable of controlling the pH of the coating solution for the protective layer to fall between 6.0 and 7.5. The catalyst may be any known acid or metal salt, and is preferably, like the crosslinking agent, one capable of controlling the pH of the coating solution for the layer to fall between 6.0 and 7.5.

The pigment may be any known inorganic or organic pigment. Specific examples include calcium carbonate, aluminium hydroxide, barium sulfate, titanium oxide, talc, agalmatolite, kaolin, calcined kaolin, amorphous silica, urea-formalin resin powder, polyethylene resin powder and benzoguanamine resin powder. One or more of these may be used herein either singly or as combined.

Preferred examples of the lubricant are zinc stearate, calcium stearate, paraffin wax and polyethylene wax.

For the surfactant, preferred are salts of sulfosuccinic acids with, for example, alkali metal salts, as well as fluorine-containing surfactants, as enabling formation of a uniform protective layer on the thermal recording layer. Specifically, they include sodium and ammonium di-(2-ethylhexyl) sulfosuccinate and di-(n-hexyl)sulfosuccinate.

The coating solution for the protective layer (protective layer-forming solution) may be prepared by mixing the above-mentioned components, to which are optionally added any of mold stripping, wax and water repellent. The protective layer may be formed by applying the protective layer coating solution onto the image-forming layer (preferably, the thermal recording layer) formed on a support, using any coating method, for example, usable is a bar coater, an air knife coater, a blade coater or a curtain coater.

The protective layer may be formed simultaneously with the other layers of image-forming layer and transmittance control layer. For example, after a coating solution for the image-forming layer has been applied onto a support and then dried to form the image-forming layer thereon, the coating solution for the protective layer may be applied onto the dried image-forming layer to form the protective layer thereon.

The dry weight of the protective layer preferably falls between 0.2 and 7 g/m², more preferably between 1 and 4 g/m². If the weight is less than 0.2 g/m², the protective layer will not be capable of ensuring good waterproofness; but if the weight is greater than 7 g/m², the thermal sensitivity of the recording layer that underlies the protective layer will be lowered. After being coated with the protective layer, the recording paper may be optionally calendered.

The adhesive recording paper of the invention has, on a substrate, a multi-layered (or single-layered) image-forming layer (preferably, thermal recording layer), which is optionally but preferably coated with a protective layer. In addition, it may optionally have other layers such as a transmittance control layer and an interlayer between the image-forming layer and the protective layer.

Substrate:

The substrate is not specifically defined. Examples include various films such as a film of polyethylene terephthalate and foams thereof, polyamide film, polyaramide film, polycarbonate film, cellophane and polypropylene film; various types of paper such as synthetic paper, coated paper and woodfree paper; and various laminates.

Since the recording paper is brought into contact with a thermal head in a recorder while it is recorded (printed), the substrate is preferably smooth and cushiony. More preferably, the thermal diffusion through it is as low as possible. For the substrate, therefore, especially preferred are polyethylene terephthalate foamed polyethylene terephthalate films.

### EXAMPLES

The invention is described in more detail with reference to the following Examples, which, however, are not intended to limit the scope of the invention. In the following Examples, “part” and “%” are all by weight.

### Example 1

First prepared was TA paper (trade name: Thermoautochrome paper, manufactured by Fuji Photo Film) which has thermal recording layers for yellow formation, magenta formation and cyan formation laminated in that order on a white polyethylene terephthalate film serving as a substrate, and which forms three colors when heated energy applied thereto.

Further, a two-component, crosslinkable acrylic adhesive was prepared by sufficiently mixing the following ingredients:

| | | |
|---|---|---|
| Acrylic Adhesive (trade name: BPS-4849-40N, | 100 | parts |
| manufactured by Toyo Ink) | | |
| Crosslinking Agent (polyfunctional aromatic | 2 | parts |
| polyisocyanate, trade name: Colonate L, manufactured | | |
| by Nippon Polyurethane Industry) | | |

For a stripping sheet, prepared was a biaxially-oriented film (trade name: Crysper, manufactured by Toyobo) , which comprises, as the essential ingredient, polyethylene terephthalate, and this was stretched and foamed. One surface to be a stripping face of the film was coated with a silicone stripping agent (trade name: LTC-750A, manufactured by Toray-Dow Corning Silicone) using gravure coating, and dried to form thereon a stripping layer having a dry weight of 0.2 ±0.05 g/m². The biaxially-oriented film was thus coated with the stripping layer.

Next, the adhesive prepared in the above was applied onto the stripping layer of the biaxially-oriented film using comma coating, and dried to form thereon an adhesive layer having a dry weight of 15±2 g/m².

The biaxially-oriented film onto which the adhesive layer was formed and the TA paper were laminated together, with the adhesive layer of the former kept in contact with the surface opposite to that with the multi-layered thermal recording layer of the latter. Multi-color, adhesive recording paper (1) of the invention was thus produced.

### Examples 2 and 3

Multi-color, adhesive recording paper (2) and (3) of the invention were produced in the same manner as in Example 1 except that the adhesive used differed from the two-component crosslinkable acrylic adhesive used in Example 1 since the adhesive (acrylic adhesive) used in these examples requires stripping force at 5° C., 23° C. and 35° C., as in Table 1 below.

### Comparative Examples 1 and 2

Multi-color, adhesive recording paper (4) and (5) for comparison were produced in the same manner as in Example 1, except that the adhesive used differed from the two-component crosslinkable acrylic adhesive used in Example 1 since the adhesive (acrylic adhesive) used in these examples requires stripping force at 5° C., 23° C. and 35° C., as in Table 1 below.

Measurement of Stripping Force:

The stripping force necessary for separating the stripping sheet from the adhesive layer of the adhesive recording paper was measured as follows: The paper to be tested was conditioned at the respective temperatures (5° C., 23° C., 35° C.) for 24 hours, and then the stripping sheet was peeled from it by a 180 degree-peeling method, at a peeling rate of 300 mm/min. In Table 1 below, the values of the stripping force are relative to the standard value of 1.00 at 23° C. (65% RH).

Image Formation and Evaluation:

The adhesive recording paper, (1) to (3) and (4) to (5) were conditioned at service temperatures (5° C., 23° C., 35° C.) for 24 hours, and then printed in a printer (trade name: Fujix Digital Color Printer NC600D, manufactured by Fuji Photo Film —this is exclusively for TA paper) at the indicated service temperatures. The printer is for a direct thermal recording system, having a resolution of 320 dpi and capable of recording 16,700,000 colors.

The full-color image thus formed on the paper was visually checked in detail for image mispositioning of yellow/magenta/cyan colors, and evaluated according to the standard mentioned below. The results are given in Table 1. The standard for the image evaluation is as follows:

ο: The image is good and there is little mispositioning.

Δ: The image is acceptable, though some mispositioning is seen.

^{x}: The image is unacceptable, as the mispositioning is great.

TABLE 1

| | Adhesive | | Service Temperature (° C.) | | | | |
|---|---|---|---|---|---|---|---|
| | Recording | Type of | | 23° C. | | Max/Min | Image Mis- |
| | Paper | Adhesive | 5° C. | (standard) | 35° C. | (*1) | registration |
| Example 1 | (1) | two-component | 0.83 | 1.00 | 1.20 | 1.45 | ∘ |
| | | cross-linkable | | | | | |
| | | acrylic adhesive | | | | | |
| Example 2 | (2) | acrylic adhesive | 0.71 | 1.00 | 1.20 | 1.69 | ∘ |
| Example 3 | (3) | acrylic adhesive | 0.50 | 1.00 | 1.70 | 3.40 | Δ |
| Comp. Ex. 1 | (4) | acrylic adhesive | 0.65 | 1.00 | 3.20 | 4.92 | x |
| Comp. Ex. 2 | (5) | acrylic adhesive | 0.55 | 1.00 | 2.20 | 4.00 | x |

(*1) Max/Min = N^{max}/N^{min}

As in Table 1 above, the adhesive recording paper (1) to (3), for which the stripping force ratio, N^{max}/N^{min}, in separating the stripping sheet from the adhesive layer is not larger than 3.5, are free from the problem of mispositioning of three colors of yellow, magenta and cyan to cause image mispositioning. If this becomes possible to reliably reproduce thereon vivid sharp-toned multi-color images of good quality with no mispositioning.

On the contrary, however, the adhesive recording paper (4) and (5), for which the stripping force ratio, N^{max}/N^{min}, in separating the stripping sheet from the adhesive layer is larger than 3.5, could not solve the problem of mispositioning of three colors of yellow, magenta and cyan thereon, and therefore, the color images formed thereon are not good and their commercial value is poor.

The present invention provides adhesive recording paper which is used in a recording process of a direct thermal recording system, a sublimation conveyance recording system or the like of forming colors of yellow (Y), magenta (M) and cyan (C) in order thereon, and which is, when used for recording (printing) multi-color images (letters) thereon, free from the problem of color mispositioning which causes image mispositioning and is therefore capable of stably reproducing thereon reliable vivid sharp-toned multi-color images of good quality without image mispositioning.

What is claimed is:

1. An adhesive recording paper, which comprises:
a substrate,
an image-forming layer provided on one surface of the substrate, and
an adhesive layer and a stripping sheet provided in that order on the other surface of the substrate, wherein the ratio, N^{max}/N^{min}, of the maximum stripping force (N^{max}) to the minimum stripping force (N^{min}) needed for separating the stripping sheet from the adhesive layer at a service temperature is at most 3.5.

2. The adhesive recording paper of claim 1, wherein the ratio N^{max}/N^{min} is at most 2.0.

3. The adhesive recording paper of claim 1, wherein the ratio N⁵/N²³ of the stripping force (N⁵) at a service temperature of 5° C. to the stripping force (N²³) at a service temperature of 23° C. falls between 0.7 and 1.3.

4. The adhesive recording paper of claim 2, wherein the ratio N⁵/N²³ of the stripping force (N⁵) at a service temperature of 5° C. to the stripping force (N²³) at a service temperature of 23° C. falls between 0.7 and 1.3.

5. The adhesive recording paper of claim 1, wherein the ratio N³⁵/N²³ of the stripping force (N³⁵) at a service temperature of 35° C. to the stripping force (N²³) at a service temperature of 23° C. falls between 0.7 and 2.0.

6. The adhesive recording paper of claim 2, wherein the ratio N³⁵/N²³ of the stripping force (N³⁵) at a service temperature of 35° C. to the stripping force (N²³) at a service temperature of 23° C. falls between 0.7 and 2.0.

7. The adhesive recording paper of claim 3, wherein the ratio N³⁵/N²³ of the stripping force (N³⁵) at a service temperature of 35° C. to the stripping force (N²³) at a service temperature of 23° C. falls between 0.7 and 2.0.

8. The adhesive recording paper of claim 4, wherein the ratio N³⁵/N²³ of the stripping force (N³⁵) at a service temperature of 35° C. to the stripping force (N²³) at a service temperature of 23° C. falls between 0.7 and 2.0.

9. The adhesive recording paper of claim 1, wherein the image-forming layer is a thermal recording layer for use in a thermal recording process in which image formation is carried out on said thermal recording layer by heat being applied thereto, and said thermal recording layer contains colloidal silica.

10. The adhesive recording paper of claim 2, wherein the image-forming layer is a thermal recording layer for use in a thermal recording process in which image formation is carried out on said thermal recording layer by heat being applied thereto, and said thermal recording layer contains colloidal silica.

11. The adhesive recording paper of claim 1, wherein the image-forming layer is a thermal recording layer for use in a thermal recording process in which image formation is carried out on said thermal recording layer by heat being applied thereto, and said thermal recording layer is coated with a protective layer that contains colloidal silica.

12. The adhesive recording paper of claim 2, wherein the image-forming layer is a thermal recording layer for use in a thermal recording process in which image formation is carried out on said thermal recording layer by heat being applied thereto, and said thermal recording layer is coated with a protective layer that contains colloidal silica.
